(19) United States
(12) Patent Application Publication
(10) Pub. No.: US 2011/0059883 A1
(43) Pub. Date: Mar. 10, 2011

(54) Methods to Improve the Compatibility and Efficiency of Powdered Versions of Microfibrous Cellulose

(75) Inventors: John McArthur Swazey, JR., San Diego, CA (US); Nicholas Madison, New York, NY (US)

(73) Assignee: CP KELCO U.S., INC., Atlanta, GA (US)

(21) Appl. No.: 12/877,308

(22) Filed: Sep. 8, 2010

Related U.S. Application Data
(60) Provisional application No. 61/240,347, filed on Sep. 8, 2009.

(51) Int. Cl. C11D 3/386; D21C 1/00; C11D 3/00

(52) U.S. Cl. 510/320; 127/44; 435/277; 510/276

(57) ABSTRACT

A method for improving the performance of a powdered microfibrous cellulose (MFC) composition is provided. The method involves degrading a co-agent in the powdered MFC composition using a polymer degrader. The polymer degrader does not substantially degrade the MFC.

### CROSS-REFERENCE TO RELATED APPLICATIONS

The present application claims the benefit of U.S. Provisional Application No. 61/240,347, filed Sep. 8, 2009. This Provisional Application is incorporated herein by reference in its entirety.

### BACKGROUND

Viscosity modifiers are used in a variety of products—from foods, pharmaceuticals, and cosmetics to oil field drilling fluids. One such viscosity modifier is microfibrous cellulose (MFC), which may be produced by fermentation of Acetobacter xylinum. This bacteria produces cellulose that is chemically identical to plant-derived cellulose. Though identical in chemical structure, MFC fibers may be smaller in diameter than plant-derived cellulose fibers, thereby giving MFC a greater surface area. This high surface area allows MFC to create three-dimensional networks that produce a desirable yield value in solution at low use levels. MFC is essentially insoluble and uncharged and, therefore, may not be not adversely affected by ionic environments. Because MFC is essentially insoluble it does not compete for water and, therefore, has a wide range of compatibility and is much less susceptible to degradation than water-soluble polysaccharides. It is compatible with both concentrated anionic aqueous solutions, such as heavy brines used in oilfield applications, and in high surfactants systems, such as liquid dish and laundry detergents. MFC is also compatible with cationic systems, such as fabric softeners using cationic softening agents and anti-microbial cleaners that use benzylalkonium chlorides.

In its pure form, MFC may be obtained as a wet cake (resembling wet cardboard), typically with about 10-20 wt % solids and the balance as water. Wet cake MFC has exceptional compatibility with aqueous systems and with many water-miscible organic solvent systems. When using wet cake MFC, the MFC is preferably “activated,” or highly dispersed under high shear conditions, either in fresh water or in a final product formulation in order for the MFC to achieve full functionality. If the pure MFC is activated as a concentrated solution for dilution into the rest of the formulation, it can usually be added to the final formulation in any order with other ingredients without affecting its performance. However, wet cake MFC is hydrophilic and, therefore, is not generally compatible with oils and other hydrophobic materials.

Despite these benefits, pure forms of MFC, including wet cake MFC, are not currently commercially produced. Instead, dry powder forms of MFC are available, including AxCel® PX, AxCel® CG-PX, Axcel® PG, Cellulon™ PX, and various “K”-named products (CP Kelco U.S., Inc.). These commercial versions of powdered MFC can be used to provide suspension in many applications, such as surfactant-thickened and high surfactant systems (see, e.g., U.S. patent application Ser. Nos. 2008/0108541, 2008/0108714, and 2008/0146485, herein incorporated by reference for their teachings on MFC and MFC/surfactant systems). These commercial versions of powdered MFC comprise a blend of MFC and various co-agents, such as, but not limited to, carboxymethyl cellulose (CMC), xanthan gum, guar, pectin, gellan, carrageenan, locust bean gum, gum Arabic, and the like. Additional information regarding MFC systems can be found, for example, in U.S. patent application Ser. Nos. 2007/0027108 and 2007/0197779, herein incorporated by reference for their teachings on MFC and MFC systems with co-agents.

These co-agents allow the drying and milling of MFC into a powdered product. Without these co-agents, MFC may lose a high degree of its functionality after drying and milling. Such blends, however, may introduce limits on how powdered MFC can be used in products due to compatibility limitations of the co-agents. For example, while MFC is uncharged, most of the co-agents that are used are either anionic or cationic. Thus, commercial MFC products may have compatibility issues when used in products with, for instance, cationic surfactants. Additionally, commercial MFC may have limited compatibility with products that contain high levels of water-miscible organic solvents, such as glycols or glycerol. When used with such organic solvents, the co-agents from the commercial MFC may form precipitates which may result in poor clarity and poor yield values. Finally, the use of activated solutions of powdered MFC may restrict the order in which other reagents are added to a product formulation, so as to prevent issues such as co-agents forming precipitates.

Accordingly, there exists a need for a powdered MFC that performs more like a pure MFC for use in a variety of product formulations.

### SUMMARY

In one aspect, methods for improving performance of a powdered MFC composition comprising an MFC and a co-agent is provided. The method can comprise combining a polymer degrader with the MFC and the co-agent for an effective amount of time to degrade the co-agent, but not substantially degrade the MFC.

In another aspect, a method for making a product formulation or for modifying the rheology of a composition using MFC is provided. The method can comprise adding a treated MFC to a desired product formulation, wherein the treated MFC is prepared by a method that may comprise combining a polymer degrader with an MFC and a co-agent for an effective amount of time to degrade the co-agent, but not substantially degrade the MFC.

Embodiments of this invention are set forth below in the following detailed description, examples, and claims. It is to be understood that both the foregoing general description and the following detailed description are exemplary and explanatory only and are not restrictive.

### DETAILED DESCRIPTION

Before the present methods are disclosed and described, it is to be understood that the aspects described below are not limited to specific embodiments, specific embodiments as such may, of course, vary. It is also to be understood that the terminology used herein is for the purpose of describing particular aspects only and is not intended to be limiting.

In this specification and in the claims which follow, reference will be made to a number of terms which shall be defined to have the following meanings^{.}

It must be noted that, as used in the specification and the appended claims, the singular forms “a,” “an,” and “the” include plural references unless the context clearly dictates otherwise. Thus, for example, reference to “an enzyme” includes mixtures of enzymes, and references to “a co-agent” include mixtures of two or more such co-agents.

Ranges may be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

A weight percent of a component, unless specifically stated to the contrary, is based on the total weight of the formulation or composition in which the component is included.

It has been discovered that though co-agents are required to make a functional MFC product in a powdered form, these co-agents can subsequently be degraded to allow the powdered MFC to function more like a pure MFC. As long as the co-agents are degraded without substantially degrading the MFC, the resulting MFC solutions have a much improved compatibility with anionics, cationics, trivalent ions, high salt levels, high surfactant levels or combinations thereof, as well as an improved ability to provide suspension in non-aqueous, but water miscible, organic solvents.

Perhaps the simplest approach to degrade the co-agent(s) to an effective extent can be to first disperse powdered MFC into an aqueous solution, preferably fresh water, for the subsequent degradation. Dispersion of the powder in water allow the co-agent(s) (e.g., xanthan gum, cellulose gum, or guar gum) to hydrate or at least reach a swollen state. Next, an effective amount of a polymer (co-agent) degrader can be added. The degradation occurs for a period of time and under reaction conditions effective to degrade the co-agent(s) to a desired degree.

After the co-agent(s) have been degraded, the degradation can be stopped, if it does not stop on its own.

The purpose of the degradation treatment of the co-agent(s) in the MFC/co-agent blend is to degrade the co-agents so severely that the co-agents no longer remain associated with the MFC or are of sufficiently low molecular weight that they will not react with any of the ingredients in a final product formulation. A visual test can be adequate to determine if the degradation of the co-agents has occurred to a sufficient degree. The visual indicator can be a strong flocculation of the MFC fibers in the solution that it was prepared in. One of the functions of co-agents, such as CMC, cationic HEC, cationic guar, and, to a lesser extent, xanthan gum and guar gum, is to maintain a well-dispersed solution of MFC. As the co-agents are degraded, flocculation of the MFC can occur. If this flocculation is not seen, it may be because the co-agents retain too much of their structure, and, therefore, additional reaction time or degrader or enhanced reaction conditions may be needed.

This invention relates to methods which can improve the compatibility, flexibility, and efficiency of currently available commercial powdered MFC.

A. Method for Improving Performance of a Powdered MFC Composition

Described herein is a method for improving performance of a powdered MFC composition comprising a co-agent(s). In one aspect, the method comprises degrading the co-agent(s) with a polymer degrader, such as a chemical breaker or an enzymatic breaker.

### MFC/Co-agents

Powdered MFC comprising co-agent(s) is commercially available. For example, xanthan and cellulose gum are the co-agents present in CP Kelco's AxCel® PX, AxCel® CG-PX, and Cellulon™ PX products, whereas guar gum and cellulose gum are the co-agents present in the AxCel® PG product. These particular commercially-available MFC products contain the co-agents cellulose gum, xanthan gum, and/or guar gum, but many other combinations have been proven successful at providing a functional version of powdered MFC, including blends with cationic guar, cationic hydroxyethyl cellulose (HEC), carrageenan, gellan, and the like.

These co-agents are typically anionically charged (except for guar, cationic guar, and cationic HEC), so they will generally react with cationic components in product formulations, such as cationic conditioning agents or cationic anti-microbial agents. This effect limits powder MFC's use in its current commercially-available forms. Also, these co-agents can reduce or eliminate the functionality of the MFC blends if these co-agents precipitate, due to some incompatibility of the co-agents, and coat the MFC fibers making it less effective at forming its reticulated structure. Examples where this co-agent precipitation can occur include very high salt formulations, high surfactant systems, or in non-aqueous systems, such as PEG, glycerol, or ethylene or propylene glycol.

### Degradation

In order to facilitate degradation, the powdered MFC comprising co-agent(s) can be added to a solvent, for example, water or blends of water and alcohols or polyols, to hydrate the co-agent(s). An effective amount and type of solvent can produce good hydration of the co-agents. Mixing can be used to facilitate the formation of a solution comprising the powdered MFC/co-agent(s).

A polymer degrader (co-agent degrader) can be added to the MFC solution to actually perform the co-agent degradation. The polymer degrader can include chemical or enzymatic “breakers.” A “breaker” is a term used in the oilfield industry in which a chemical or enzyme is used to break or significantly reduce the viscosity of thickening agents in drilling fluids, completion fluids, or stimulation fluids. Mixing can be used to facilitate addition of the polymer degrader to the solution.

In one aspect, a method for improving performance of a powdered MFC composition is provided. In accordance with embodiments of the invention, a powdered MFC composition demonstrates “improved performance” when the MFC fibers show visible flocculation in the solution in which they were prepared. As used herein, a “powdered MFC composition” comprises MFC and a co-agent. A powdered MFC composition can comprise a co-agent in various amounts. In one embodiment, a powdered MFC composition comprises a co-agent in the range of about 10 wt % to about 90 wt % or in the range of about 20 wt % to about 50 wt % of the powdered MFC composition.

As used herein, the term “co-agent” refers to one or more co-agents. In an embodiment, the co-agent can be an ionic or a non-ionic polymeric material. In some embodiments, the co-agent can be a polysaccharide. In other embodiments, the co-agent can be, but is not limited to, carboxymethyl cellulose (CMC), hydroxyethyl cellulose (CEC), xanthan gum, guar, pectin, gellan, carrageenan, locust bean gum, or gum Arabic.

A method for improving performance of a powdered MFC composition can comprise a first step of combining an effective amount of a polymer degrader with a powdered MFC composition comprising MFC and a co-agent for an effective amount of time to degrade the co-agent.

As used herein, the term “polymer degrader” refers to any substance capable of reducing the molecular weight of a polymer by breaking multiple chemical bonds of the polymer. As used herein, “multiple chemical bonds” refers to two or more covalent bonds, wherein each of the bonds may be a single bond, a double bond, or a triple bond. As used herein, the term “degrade” refers to breaking multiple chemical bonds of a polymer.

In some embodiments, an effective amount of a polymer degrader can be an amount of polymer degrader to degrade an effective amount of co-agent. In some embodiments, a visual test can be adequate to determine if the degradation of the co-agents has occurred to an effective amount. The visual indicator can be the appearance of flocculation of the MFC fibers in the solution in which it was prepared. Without being limited to any one theory, a function of the co-agents is to maintain the dispersion of the MFC in solution. As the co-agents are degraded, flocculation of the MFC can occur. If this flocculation is not observed, it may be because the co-agents retain too much of their structure, and, therefore, an effective amount of the co-agent may not have been degraded.

In some embodiments, an effective amount of time to degrade the co-agent can be an amount of time to degrade a desirable amount of the co-agent. For example, in some embodiments an effective amount of time can be up to about 72 hours, up to about 48 hours, up to about 24 hours, up to about 1 hour, up to about 30 minutes, up to about 5 minutes, or up to about 1 minute.

In a method for improving performance of a powdered MFC composition, MFC is preferably not substantially degraded. As used herein, “not substantially degraded” means that the MFC remains substantially intact after treatment of the powdered MFC composition with a polymer degrader.

### Chemical

In some embodiments, the polymer degrader can be a chemical breaker, an enzymatic breaker, or combinations thereof. As used herein, the term “chemical breaker” refers to one or more chemical agents, which are not enzymes, that are capable of breaking multiple chemical bonds of the co-agent. As used herein, the term “enzymatic breaker” refers to one or more enzymes that are capable of breaking multiple chemical bonds of the co-agent.

One example method comprises use of a chemical breaker. The chemical breaker can be an oxidizing agent such as hydrogen peroxide or sodium hypochlorite. When used at the appropriate levels, a peroxide or bleaching agent can quickly break down the co-agent(s) present to very low molecular weight products. The MFC, on the other hand, can be quite stable to these reagents, especially over the time scale that may be needed to break down the co-agent(s). The remaining oxidizer can be reacted out of the system, for example, by adjusting pH or adding trivalent cations (e.g., Fe³⁺) to quickly react with any residual oxidizing or bleaching reagents.

In some embodiments, the polymer degrader can be a chemical breaker. In an embodiment, the chemical breaker comprises a chemical that is capable of degrading the co-agent. In still other embodiments, the chemical breaker can comprise an oxidizing agent. In yet other embodiments, the chemical breaker can be, but is not limited to, hydrogen peroxide, calcium peroxide, ammonium persulfate, sodium percarbonate, urea peroxide, sodium perborate, sodium hypochlorite, lithium hypochlorite, hydrochloric acid, sodium hydroxide, and/or combinations thereof. One of ordinary skill in the art can determine other chemical breakers such as by looking to the oil field art. The choice of breaker and the breaker concentration will depend in large part on how quickly one desires the viscosity break to occur and under what conditions the breaker is required to perform (e.g., pH and temperature of the solution). One of ordinary skill in the art can match a breaker with effective amount, timing, and reaction conditions.

The adjustment of reaction conditions can facilitate co-agent degradation. It is important to note that MFC is not completely impervious to degradation by chemical breakers, but it is generally affected much more slowly than the water-soluble co-agents. In some embodiments, after adding a chemical breaker to the powdered MFC composition, the pH of the mixture can be adjusted up or down to facilitate the degradation of the co-agent. In still another embodiment, after adding a chemical breaker to the powdered MFC composition, the temperature of the mixture can be adjusted up or down to facilitate the degradation of the co-agent. One of ordinary skill in the art can determine facilitating reaction conditions.

### Enzymatic

Another example method comprises the use of an enzyme to break down the co-agent(s). For example, gummase and cellulase can be used in the case of guar gum and cellulose gum blends with MFC (e.g., AxCel® PG), or xanthanase and cellulase can be used in the case of xanthan gum and cellulose gum blends with MFC (e.g., AxCel® PX). Although the MFC can also be susceptible to degradation by cellulase, it usually degrades at a rate that is several orders of magnitude slower than for soluble forms of cellulose (such as cellulose gum), so the degradation can usually be neutralized (by, e.g., pasteurization, high pH, oxidation treatment, or by adding the solution to a formulation where the enzyme is not active) before the cellulase shows any noticeable effect on the MFC.

An effective amount of an effective enzymatic breaker can be added to the solution. For enzymatic breakers, the type of enzyme(s) used will depend on the types of co-agent(s) to be degraded. One of ordinary skill in the art can determine an appropriate enzyme or enzyme mix. For example, cellulase will be effective with a cellulose gum co-agent, but it is preferable to use gummase with guar gum. Xanthan gum is not normally degraded by either of these enzymes, so a xanthanase enzyme is required when removing a xanthan gum co-agent. It is important to note that any cellulase enzyme used to breakdown a cellulose gum co-agent can eventually degrade the MFC, as well. However, the degradation is much slower for MFC than the soluble cellulose gum co-agent, such that there is ordinarily sufficient time to deactivate the enzyme after a cellulose gum co-agent is destroyed before any significant degradation has occurred with the MFC fiber. The choice of enzymatic breaker concentration can depend on how fast one desires the viscosity break to occur and under what conditions the breaker may be required to perform under (e.g., time, pH, temperature, and salinity of the solution).

Adjustment of reaction conditions when using enzyme(s) can facilitate co-agent degradation. For example, heating the solution to about 45° C. can often accelerate the rate of enzymatic break of the co-agent(s). Also, adjusting the pH to the optimal pH for the particular enzyme activity can accelerate the rate of enzymatic break of the co-agent(s). Thus, one of ordinary skill in the art can choose an enzymatic degrader and reaction conditions to minimize degradation of the MFC while still achieving sufficient degradation of the co-agent(s).

In some embodiments, the polymer degrader can be an enzymatic breaker. In an embodiment, the enzymatic breaker comprises an enzyme effective to degrade the co-agent. As used herein, “effective to degrade the co-agent” means that the enzyme can break multiple chemical bonds of the co-agent polymer. In some embodiments, the enzymatic breaker can be, but is not limited to, cellulase, xanthanase, gummase, and/or combinations thereof. In other embodiments, after adding an enzymatic breaker to the powdered MFC composition, the pH of the mixture can be adjusted up or down to facilitate the degradation of the co-agent. In still another embodiment, after adding an enzymatic breaker to the powdered MFC composition, the temperature of the mixture can be adjusted up or down to facilitate the degradation of the co-agent.

### “Quenching”

In an embodiment, the method for improving performance of a powdered MFC composition can further comprise quenching the polymer degrader after the co-agent is degraded. As used herein, “quenching” refers to, e.g., physical and/or chemical deactivation of the polymer degrader such that the polymer degrader will no longer undergo reaction with the co-agent. Methods of quenching, which are known to those of skill in the art, include adjusting temperature, adjusting pH, or both. Additionally, in some embodiments the polymer degrader can be quenched by an additional step of adding a quenching agent. Another method can be to perform the degradation of the co-agent with only a small amount of a polymer degrader such that there is a sufficient amount of a polymer degrader to degrade the co-agents, but not enough to significantly damage the MFC.

If a chemical breaker is not completely reacted during the degradation process, it is preferred that the chemical breaker be “reacted out” of the solution (or “quenched”). This can often be done by adjusting the pH in a direction to destabilize the chemical breaker so that it can be consumed quickly and completely. Another method can be to carry out the degradation starting with only a small amount of chemical breaker so that there is a sufficient amount to break down the co-agent(s), but not enough to significantly damage the MFC fibers. One of ordinary skill in the art can determine other methods for cessation of chemical degradation.

An enzymatic degrader can be deactivated by various methods. In one embodiment, a method for deactivating an enzymatic degrader comprises pasteurizing the MFC solution containing enzymes at sufficient temperature to degrade the enzymes. In another embodiment, a method for deactivating the enzymatic degrader comprises adding a solution of sufficient ionic strength to the MFC solution containing enzymes to deactivate the enzymes. In still another embodiment, a method for deactivating the enzymatic degrader comprises adding a solution of a particular pH to the MFC solution containing enzymes to deactivate the enzymes. Another method to deactivate an enzyme is denaturing the enzyme. As used herein, the term “deactivate” refers to stopping the catalytic reactivity of an enzyme. One of ordinary skill in the art may determine other methods of deactivating an enzymatic breaker.

The method for improving performance of a powdered MFC composition also can comprise dispersing the powdered MFC composition comprising MFC and a co-agent in an amount of a solvent effective to hydrate the co-agent and to form a dispersion. In some embodiments, the solvent is one or more liquids. In one embodiment, the solvent is water. In some embodiments, the water can be fresh water, demineralized water, brackish water, tap water, or the like.

In another embodiment, the solvent can comprise an alcohol. In other embodiments, the solvent can comprise a polyol. As used herein, the term “an alcohol” refers to one or more alcohols. In still other embodiments, the solvent can comprise, but is not limited to, methanol, ethanol, isopropanol, glycerol, polyethylene glycol, propylene glycol, ethylene glycol, phenethyl alcohol, benzyl alcohol, and/or combinations thereof. In some embodiments, the solvent can comprise water and one or more alcohols and/or one or more polyols. In still other example embodiments, the solvent can be a 1:1 ratio of water to an alcohol, a 2:1 ratio of water to an alcohol, a 3:1 ratio of water to an alcohol, a 4:1 ratio of water to an alcohol, or a 10:1 ratio of water to an alcohol.

The method can further comprise dispersing the powdered MFC composition in an amount of a solvent effective to hydrate the co-agent. In some embodiments, the amount of a solvent effective to hydrate the co-agent may be enough solvent to completely hydrate the co-agent. In other embodiments, the amount of a solvent effective to hydrate the co-agent may be enough solvent to cause the co-agent to reach a swollen state. In still other embodiments, the amount of a solvent effective to hydrate the co-agent may be enough solvent so that the co-agent completely dissolves into solution. In other embodiments, the amount of a solvent effective to hydrate the co-agent may be enough solvent to partially hydrate the co-agent.

A method for improving performance of a powdered MFC composition can comprise adding an effective amount of a polymer degrader to the dispersion for an effective amount of time to degrade the co-agent.

In some embodiments, a method for improving performance of a powdered MFC composition can further comprise mixing the dispersion.

Moreover, in some embodiments, a method for improving performance of a powdered MFC composition can further comprise mixing the dispersion after adding an effective amount of a polymer degrader to the dispersion. In some embodiments, mixing can be stopped just prior to addition of the polymer degrader to the dispersion, and then mixing can be re-started once the addition of polymer degrader is complete. In other embodiments, continuous mixing can be used throughout the addition of polymer degrader to the dispersion. In still other embodiments, the speed of mixing can be increased or decreased during the addition of the polymer degrader to the dispersion. In yet other embodiments, the speed of mixing can be increased or decreased during the addition of the polymer degrader to the dispersion, and then the speed of mixing can again be increased or decreased after the addition of polymer degrader is completed.

Polymer degraders can be used individually or in combinations. One of ordinary skill in the art can adjust the other steps accordingly based on the polymer degrader(s) used.

B. Method for Making a Product Formulation Using MFC

In another aspect, a method for making a product formulation using MFC is provided. This method comprises adding a treated MFC to a product formulation, wherein the treated MFC is prepared according to a method. As used herein, a “product formulation” can include, but is not limited to, any product, including foods, pharmaceuticals, cosmetics, personal care products, and oil field drilling fluids.

A method for preparing the treated MFC comprises optionally dispersing a powdered MFC composition comprising MFC and a co-agent in an amount of solvent effective to hydrate the co-agent and form a dispersion. Alternatively, the method for preparing the treated MFC may comprise using no solvent and forming no dispersion, using only the powdered MFC composition. The method further comprises adding an effective amount of a polymer degrader to the dispersion or the powdered MFC composition for an effective amount of time to degrade the co-agent. In another aspect, the polymer degrader does not substantially degrade the MFC.

The definitions for the terms “powdered MFC composition,” “co-agent,” “polymer degrader,” “effective amount of a polymer degrader to degrade an effective amount of a co-agent,” “effective amount of time to degrade an effective amount of a co-agent,” “solvent,” “effective to hydrate,” and “the polymer degrader does not substantially degrade the MFC” are the same as defined above.

In one embodiment, a product formulation comprising the treated MFC has a higher yield than the product formulation comprising an untreated powdered MFC. Thus, in at least some embodiments, the product formulation can have a higher yield when prepared using the treated MFC compared to the same product formulation prepared using commercially-available powdered MFC.

In another embodiment, the product formulation comprising the treated MFC is substantially clear. As used herein, the term “substantially clear” means that upon visual inspection, cloudiness is not observed in the product formulation. In other embodiments, substantially clear may mean that no fibrous material is observed in the product formulation. In yet another embodiment, substantially clear means that only a slight haze is observed.

In some embodiments, the polymer degrader can be a chemical breaker, an enzymatic breaker, or combinations thereof. As used herein, the term “chemical breaker” refers to one or more chemical agents, which are not enzymes, that are capable of breaking multiple chemical bonds of the co-agent. As used herein, the term “enzymatic breaker” refers to one or more enzymes that are capable of breaking multiple chemical bonds of the co-agent.

One example method comprises use of a chemical breaker. The chemical breaker can be an oxidizing agent such as hydrogen peroxide or sodium hypochlorite. When used at the appropriate levels, a peroxide or bleaching agent can quickly break down the co-agent(s) present to very low molecular weight products. The MFC, on the other hand, can be quite stable to these reagents, especially over the time scale that may be needed to break down the co-agent(s). The remaining oxidizer can be reacted out of the system, for example, by adjusting pH or adding trivalent cations (e.g., Fe³⁺) to quickly react with any residual oxidizing or bleaching reagents.

In some embodiments, the polymer degrader can be a chemical breaker. In an embodiment, the chemical breaker comprises a chemical that is capable of degrading the co-agent. In still other embodiments, the chemical breaker can comprise an oxidizing agent. In yet other embodiments, the chemical breaker can be, but is not limited to, hydrogen peroxide, calcium peroxide, ammonium persulfate, sodium percarbonate, urea peroxide, sodium perborate, sodium hypochlorite, lithium hypochlorite, hydrochloric acid, sodium hydroxide, and/or combinations thereof. One of ordinary skill in the art can determine other chemical breakers such as by looking to the oil field art. The choice of breaker and the breaker concentration will depend in large part on how quickly one desires the viscosity break to occur and under what conditions the breaker is required to perform (e.g., pH and temperature of the solution). One of ordinary skill in the art can match a breaker with effective amount, timing, and reaction conditions.

The adjustment of reaction conditions can facilitate co-agent degradation. It is important to note that MFC is not completely impervious to degradation by chemical breakers, but it is generally affected much more slowly than the water-soluble co-agents. In some embodiments, after adding a chemical breaker to the powdered MFC composition, the pH of the mixture can be adjusted up or down to facilitate the degradation of the co-agent. In still another embodiment, after adding a chemical breaker to the powdered MFC composition, the temperature of the mixture can be adjusted up or down to facilitate the degradation of the co-agent. One of ordinary skill in the art can determine facilitating reaction conditions.

Another example method comprises the use of an enzyme to break down the co-agent(s). For example, gummase and cellulase can be used in the case of guar gum and cellulose gum blends with MFC (e.g., AxCel® PG), or xanthanase and cellulase can be used in the case of xanthan gum and cellulose gum blends with MFC (e.g., AxCel® PX). Although the MFC can also be susceptible to degradation by cellulase, it usually degrades at a rate that is several orders of magnitude slower than for soluble forms of cellulose (such as cellulose gum), so the degradation can usually be neutralized (by, e.g., pasteurization, high pH, oxidation treatment, or by adding the solution to a formulation where the enzyme is not active) before the cellulase shows any noticeable effect on the MFC.

An effective amount of an effective enzymatic breaker can be added to the solution. For enzymatic breakers, the type of enzyme(s) used will depend on the types of co-agent(s) to be degraded. One of ordinary skill in the art can determine an appropriate enzyme or enzyme mix. For example, cellulase will be effective with a cellulose gum co-agent, but it is preferable to use gummase with guar gum. Xanthan gum is not normally degraded by either of these enzymes, so a xanthanase enzyme is required when removing a xanthan gum co-agent. It is important to note that any cellulase enzyme used to breakdown a cellulose gum co-agent can eventually degrade the MFC, as well. However, the degradation is much slower for MFC than the soluble cellulose gum co-agent, such that there is ordinarily sufficient time to deactivate the enzyme after a cellulose gum co-agent is destroyed before any significant degradation has occurred with the MFC fiber. The choice of enzymatic breaker concentration can depend on how fast one desires the viscosity break to occur and under what conditions the breaker may be required to perform under (e.g., time, pH, temperature, and salinity of the solution).

Adjustment of reaction conditions when using enzyme(s) can facilitate co-agent degradation. For example, heating the solution to about 45° C. can often accelerate the rate of enzymatic break of the co-agent(s). Also, adjusting the pH to the optimal pH for the particular enzyme activity can accelerate the rate of enzymatic break of the co-agent(s). Thus, one of ordinary skill in the art can choose an enzymatic degrader and reaction conditions to minimize degradation of the MFC while still achieving sufficient degradation of the co-agent(s).

In some embodiments, the polymer degrader can be an enzymatic breaker. In an embodiment, the enzymatic breaker comprises an enzyme effective to degrade the co-agent. As used herein, “effective to degrade the co-agent” means that the enzyme can break multiple chemical bonds of the co-agent polymer. In some embodiments, the enzymatic breaker can be, but is not limited to, cellulase, xanthanase, gummase, and/or combinations thereof. In other embodiments, after adding an enzymatic breaker to the powdered MFC composition, the pH of the mixture can be adjusted up or down to facilitate the degradation of the co-agent. In still another embodiment, after adding an enzymatic breaker to the powdered MFC composition, the temperature of the mixture can be adjusted up or down to facilitate the degradation of the co-agent.

E. Applications

The compositions with degraded co-agents can be used in a variety of product formulations and applications. Solutions of commercial powdered MFC can, for example, be treated with peroxide and then effectively used in cationic fabric softeners and cationic cleaners. By comparison, untreated commercial powdered MFC solutions will react strongly with these cationic systems and lead to strong precipitation. Also, these treated MFC solutions can work effectively to thicken or provide suspension in PEG 300 and propylene glycol solutions containing only the water contributed by the 1 wt % aqueous solutions of treated commercial powdered MFC as it is incorporated. Additionally, treated powdered MFC solutions have a relative insensitivity to order of addition into high surfactant systems, whereas untreated powdered MFC solutions show significant sensitivity to order of addition.

The compositions and the methods disclosed hereinabove can be used to make, e.g., bodywashes, hand soaps, and shampoos that incorporate the smooth, rich thickening obtained by surfactant-thickening agents, but with the ability to suspend matter due to the higher yield imparted by the treated powdered MFC. Also, the compositions and the methods of this disclosure can be used to make dishwashing soap with suspended actives (e.g., moisturizing beads) or decorative items or laundry detergents with suspended actives, such as insoluble enzymes, encapsulated actives, and zeolites. The compositions and the methods of this disclosure can also be useful with cationic systems like fabric softeners, anti-microbial cleaners, skin lotions, and hair conditioners containing cationic surfactants. Finally, the compositions and the methods of this disclosure can be useful to provide suspension to non-aqueous systems like PEG solutions used as carrier fluids to suspend hydrocolloids or other particulate material.

The present disclosure is further illustrated by the following examples, which are not to be construed in any way as imposing limitations upon the scope thereof. On the contrary, it is to be clearly understood that resort may be had to various other embodiments, modifications and equivalents thereof which, after reading the description therein, may suggest themselves to those skilled in the art without departing from the spirit of the present invention and/or the scope of the appended claims.

### EXAMPLES

### Example 1

Enzymatically degrading carboxymethylcellulose (CMC) gum in a powdered version of MFC

Step 1: 200 g of a 1 wt % aqueous solution of a powdered MFC (CP Kelco U.S., Inc., Atlanta, Ga.), which contains 6 parts by weight MFC and 4 parts by weight CMC, was prepared. The powdered MFC was activated by mixing the solution on a consumer-type Oster mixer (model 6820) at about 18,000 rpm for 5 minutes in a closed 250 mL plastic mixing container.

Performance Test A: 25 g of the 1 wt % solution prepared in Step 1 was added to a 200 mL container, and 175 g of All® 3× Concentrated Small & Mighty liquid laundry detergent (Unilever, Trumbull, Conn.) was slowly added with mixing at 800 rpm. After the addition was completed, the resulting solution was de-aired by centrifugation and tested for yield using a Brookfield DV-III Ultra viscometer with EZ-Yield software. The yield was measured using an LV spring, #71 vane tool at 0.05 rpm.

Results: The yield was about 0.2 Pa. The thickened liquid laundry detergent composition had poor clarity with visible fibrous material in the composition. The presence of visible fibrous material indicated precipitation of the co-agents.

Step 2: 4 drops of Multifect CL industrial cellulase enzyme (Danisco Inc., Genencor division, Rochester, N.Y.) were added to 200 g of a 1 wt % aqueous solution of a powdered MFC (as in Step 1) under propeller mixing at about 800 rpm. A small increase in the size of the mixing vortex was observed after the enzyme was added.

Performance Test B: 25 g of the 1 wt % solution prepared in Step 2 was added to a 200 mL container, and 175 g of All® 3× Concentrated Small & Mighty liquid laundry detergent (Unilever, Trumbull, Conn.) was slowly added with mixing at 800 rpm. After the addition was completed, the resulting solution was de-aired by centrifugation and tested for yield using a Brookfield DV-III Ultra viscometer with EZ-Yield software. The yield was measured using an LV spring, #71 vane tool at 0.05 rpm.

Results: The yield was about 0.9 Pa. The thickened liquid laundry detergent composition was clear, and no fibrous material was visible.

Step 3: 4 drops of Multifect CL industrial cellulase enzyme (Danisco Inc., Genencor division, Rochester, N.Y.) were added to 200 g of a 1 wt % aqueous solution of a powdered MFC (as in Step 1) under propeller mixing at about 800 rpm. The pH of the solution was adjusted to about pH 6.0 (from pH 7.7) by addition of about 2.5 wt % (based on the weight of the MFC solution) of a 1.0 M sodium citrate buffer solution. This was to optimize the pH of the system for the cellulase enzyme to work. An additional 3 drops of Multifect® CL cellulose enzyme were then added to the solution. The solution was allowed to sit overnight at ambient temperature. After overnight aging, flocculation of the microfibrous cellulose was observed in the solution, which indicated degradation of the CMC.

Performance Test C: 25 g of the 1 wt % solution prepared in Step 3 was added to a 200 mL container, and 175 g of All® 3× Concentrated Small & Mighty liquid laundry detergent (Unilever, Trumbull, Conn.) was slowly added with mixing at 800 rpm. After the addition was completed, the resulting solution was de-aired by centrifugation and tested for yield using a Brookfield DV-III Ultra viscometer with EZ-Yield software. The yield was measured using an RV spring, #71 vane tool at 0.05 rpm.

Results: The yield was about 3.5 Pa. The thickened liquid laundry detergent composition had excellent clarity with only a small amount of haze; no fibrous material was observed.

### Example 2

Chemical degradation of xanthan gum and cellulose gum co-agents in a powdered version of MFC

Step 1: 200 g of a 1 wt % aqueous solution of a powdered MFC (AxCel® CG-PX, CP Kelco U.S., Inc., San Diego, Calif.), which contained 6 parts MFC, 3 parts xanthan gum, and 1 part CMC, was prepared. The MFC solution was activated by mixing the solution with a consumer-type Oster mixer (model 6820) at top speed (about 18,000 rpm) for 5 minutes in a closed 250 mL container.

Performance Test A: 25 g of the 1 wt % MFC solution (from Step 1) was added to a 200 mL container, and then 175 g of propylene glycol was slowly added to it while mixing at about 800 rpm. The solution was transferred to a 250 g Oster blending cup and mixed at top speed for 1 minute. The solution was de-aired using a vacuum and tested for yield value using a Brookfield DV-III Ultra viscometer with EZ-Yield software. The yield was measured using an LV spring, #71 vane tool at 0.05 rpm.

Results: The yield was 1.10 Pa. The solution had good clarity.

Performance Test B: 25 g of the 1 wt % MFC solution (prepared in Step 1) was added to a 200 mL container, and 175 g of polyethylene glycol 300 (PEG 300 or PEG 6; Atlas Chemical, San Diego, Calif.) was slowly added while mixing at 800 rpm. The solution was transferred to a 250 mL closed-cup Oster container. The solution was mixed at top speed (about 18,000 rpm) on an Oster blender (model 6820) for 1 minute. The solution was de-aired using a centrifuge and tested for yield value using a Brookfield DV-III Ultra viscometer with EZ-Yield software. The yield was measured using an LV spring, #71 vane tool at 0.05 rpm.

Results: The yield was 0.47 Pa. The solution had a strongly-distorted clarity.

Step 2: Hydrogen peroxide was added to the 1 wt % MFC solution (prepared in Step 1) at a level of 0.25 wt % based on the total weight of the MFC solution. The hydrogen peroxide was added as a commercially available 30 wt % hydrogen peroxide aqueous solution (Fisher Scientific). The resulting MFC solution was then placed into a laboratory oven at 45° C. for 3 days. After aging in the oven, obvious flocculation of the MFC in the 1 wt % solution was observed, which confirmed degradation of the CMC. No visual signs were able to confirm the degradation of xanthan gum, however.

Performance Test C: 25 g of the 1 wt % MFC solution with the added hydrogen peroxide (from Step 2) was added to a 200 mL container, and then 175 g of propylene glycol was slowly added to it while mixing at about 800 rpm. The solution was transferred to a 250 g Oster blending cup and mixed at top speed (about 18,000 rpm) for 1 minute. The solution was de-aired using a vacuum and tested for yield value using a Brookfield DV-III Ultra viscometer with EZ-Yield software. The yield was measured using an RV spring, #71 vane tool at 0.05 rpm.

Results: The yield was 2.1 Pa. The resulting composition had excellent clarity with no signs of fibrous material.

Performance Test D: 25 g of the 1 wt % MFC solution with the added hydrogen peroxide (prepared in Step 2) was added to a 200 mL container, and 175 g of polyethylene glycol 300 (PEG 300 or PEG 6; Atlas Chemical, San Diego, Calif.) was slowly added while mixing at 800 rpm. The solution was transferred to a 250 mL closed-cup Oster container. The solution was mixed at top speed (about 18,000 rpm) on an Oster blender (model 6820) for 1 minute. The solution was de-aired using a centrifuge and tested for yield value using a Brookfield DV-III Ultra viscometer with EZ-Yield software. The yield was measured using an RV spring, #71 vane tool at 0.05 rpm.

Results: The yield was 1.4 Pa. The resulting composition had excellent clarity.

### Example 3

Chemical degradation of xanthan gum and cellulose gum co-agents in a powdered version of MFC

Step 1: 1.2 liters of a 1 wt % aqueous solution of a powdered MFC (AxCel® CG-PX, CP Kelco U.S., Inc., San Diego, Calif.), which contained 6 parts MFC, 3 parts xanthan gum, and 1 part cellulose gum, was prepared. The MFC solution was activated by mixing the solution with a Silverson L4RT-A homogenizer at 10,000 rpm for 10 minutes. The fine emulsion screen was used.

Performance Test A: 25 g of the 1 wt % MFC solution (prepared in Step 1) was added to a 200 mL container and then 175 g of Tide® 2× Free & Clear HE liquid laundry detergent (Procter & Gamble, Cincinnati, Ohio) was added. The solution was mixed on a stirbench at 1000 rpm for 5 minutes with a propeller mixing rod. The resulting solution was de-aired by centrifugation and tested for yield using a Brookfield DV-III Ultra viscometer with EZ-Yield software. The yield was measured using an LV spring, #71 vane tool at 0.05 rpm.

Results: The yield was 0.2 Pa.

Step 2: Hydrogen peroxide was added to the 1 wt % MFC solution (prepared in Step 1) at a level of 0.25 wt % based on the total weight of the MFC solution. The hydrogen peroxide was added as a commercially available 30 wt % hydrogen peroxide aqueous solution (Fisher Scientific). The resulting MFC solution was then placed into a laboratory oven at 60° C. for 16 hours. After aging in the oven, obvious flocculation of the MFC in the 1 wt % solution was observed, which confirmed degradation of the CMC. No visual signs were able to confirm the degradation of xanthan gum, however.

Performance Test B: 25 g of the 1 wt % MFC solution (prepared in Step 2) was added to a 200 mL container and then 175 g of Tide® 2× Free & Clear HE liquid laundry detergent (Procter & Gamble) was added. The solution was mixed on a stirbench at 1000 rpm for 5 minutes with a propeller mixing rod. The resulting solution was de-aired by centrifugation and tested for yield using a Brookfield DV-III Ultra viscometer with EZ-Yield software. The yield was measured using an RV spring, #71 vane tool at 0.05 rpm.

Results: The yield was 2.72 Pa.

### Example 4

Chemical degradation of guar gum and cellulose gum co-agents in a powdered version of MFC

Step 1: 1.2 liters of a 1 wt % aqueous solution of a powdered MFC (AxCel® PG, CP Kelco U.S., Inc., San Diego, Calif.), which contained 3 parts MFC, 1 part guar gum, and 1 part cellulose gum, was prepared. The MFC solution was activated by mixing the solution with a Silverson L4RT-A homogenizer at 10,000 rpm for 10 minutes. The fine emulsion screen was used.

Performance Test A: 25 g of the 1 wt % MFC solution (prepared in Step 1) was added to a 200 ml container and then 175 g of Tide® 2× Free & Clear HE liquid laundry detergent (Procter & Gamble) was added. The solution was mixed on a stirbench at 1000 rpm for 5 minutes with a propeller mixing rod. The resulting solution was de-aired by centrifugation and tested for yield using a Brookfield DV-III Ultra viscometer with EZ-Yield software. The yield was measured using an LV spring, #71 vane tool at 0.05 rpm.

Results: The yield was 0.03 Pa.

Step 2: Hydrogen peroxide was added to the 1 wt % MFC solution (prepared in Step 1) at a level of 0.25 wt % based on the total weight of the MFC solution. The hydrogen peroxide was added as a commercially available 30 wt % hydrogen peroxide aqueous solution (Fisher Scientific). The resulting MFC solution was then placed into a laboratory oven at 60° C. for 16 hours. After aging in the oven, obvious flocculation of the MFC in the 1 wt % solution was observed, which confirmed degradation of the CMC. No visual signs were able to confirm the degradation of guar gum, however.

Performance Test B: 25 g of the 1 wt % MFC solution (prepared in Step 2) was added to a 200 ml container and then 175 g of Tide® 2× Free & Clear HE liquid laundry detergent (Procter & Gamble) was added. The solution was mixed on a stirbench at 1000 rpm for 5 minutes with a propeller mixing rod. The resulting solution was de-aired by centrifugation and tested for yield using a Brookfield DV-III Ultra viscometer with EZ-Yield software. The yield was measured using an RV spring, #71 vane tool at 0.05 rpm.

Results: The yield was 2.40 Pa.

It should be apparent that the foregoing relates only to the preferred embodiments of the present invention and that numerous changes and modifications may be made herein without departing from the spirit and the scope of the invention as defined by the following claims and equivalents thereof.

What is claimed is:

1. A method for improving performance of a powdered microfibrous cellulose (MFC) composition comprising an MFC and a co-agent, the method comprising:
combining a polymer degrader with the MFC and the co-agent for an effective amount of time to degrade the co-agent, but not substantially degrade the MFC.

2. The method of claim 1, wherein the combining step comprises dispersing the MFC, the co-agent, and the polymer degrader in an amount of a solvent effective to hydrate the co-agent to form a dispersion.

3. The method of claim 2, wherein the solvent comprises water.

4. The method of claim 2, wherein the solvent is water, alcohol, polyol, and/or combinations thereof

5. The method of claim 1, further comprising quenching the polymer degrader after the co-agent is degraded.

6. The method of claim 1, wherein the polymer degrader is a chemical breaker, an enzymatic breaker, and/or combinations thereof.

7. The method of claim 6, wherein the chemical breaker comprises an oxidizing agent.

8. The method of claim 6, wherein the chemical breaker is hydrogen peroxide, calcium peroxide, ammonium persulfate, sodium percarbonate, urea peroxide, sodium perborate, sodium hypochlorite, lithium hypochlorite, hydrochloric acid, sodium hydroxide, and/or combinations thereof.

9. The method of claim 6, wherein the enzymatic breaker comprises an enzyme effective to degrade the co-agent.

10. The method of claim 9, wherein the enzymatic breaker is cellulase, xanthanase, gummase, and/or combinations thereof.

11. The method of claim 1, further comprising adjusting the temperature, the pH, or both.

12. The method of claim 1, wherein the amount of time to degrade the co-agent is determined visually by observing flocculation of the MFC.

13. A method for making a product formulation using MFC, comprising:
adding a treated MFC to a product formulation, wherein the treated MFC is prepared by a method comprising:
combining a polymer degrader with an MFC and a co-agent for an effective amount of time to degrade the co-agent, but not substantially degrade the MFC.

14. The method of claim 13, wherein the product formulation comprising the treated MFC has a higher yield than the product formulation comprising an untreated powdered MFC.

15. The method of claim 13, wherein the product formulation comprising the treated MFC is substantially clear.

16. The method of claim 13, wherein the polymer degrader is a chemical breaker, an enzymatic breaker, and/or combinations thereof.

17. The method of claim 16, wherein the chemical breaker comprises an oxidizing agent.

18. The method of claim 16, wherein the chemical breaker is hydrogen peroxide, calcium peroxide, ammonium persulfate, sodium percarbonate, urea peroxide, sodium perborate, sodium hypochlorite, lithium hypochlorite, hydrochloric acid, sodium hydroxide, and/or combinations thereof.

19. The method of claim 16, wherein the enzymatic breaker comprises an enzyme effective to degrade the co-agent.

20. The method of claim 16, wherein the enzymatic breaker is cellulase, xanthanase, gummase, and/or combinations thereof.
